(19) United States
(12) Patent Application Publication
(10) Pub. No.: US 2005/0080659 A1
(43) Pub. Date: Apr. 14, 2005

(54) Server including an encoded data converter apparatus

(76) Inventors: Shun Takeda, Yokohama (JP); Takashi Shinoda, Nagareyama (JP); Takashi Kai, Kawasaki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/951,597

(22) Filed: Sep. 29, 2004

(30) Foreign Application Priority Data
Oct. 1, 2003 (JP) 2003-342879

(51) Int. Cl. G06F 17/60

(52) U.S. Cl. 705/8

(57) ABSTRACT

An electronic application system comprises a local-government-shared server, a plurality of resident terminals and a plurality of local-government terminals. The local-government-shared server includes a first network connection unit, an encoded data converter apparatus, a reference table generation unit, a reference table storage unit, an encoded data storage unit, a second network connection unit, a reference table search unit and a data access control unit. The encoded data converter apparatus converts encoded data (generated by encoding application data to be transmitted from a resident terminal to a local-government terminal) of an external protocol into encoded data of an internal protocol while securing the confidentiality of plain text data which is obtained when the encoded data is temporarily decoded. For each application data, the encoded data converter apparatus generates a reference record so that the record can be referred to before the local-government terminal obtains the application data.

### INCORPORATION BY REFERENCE

The present application claims priority from Japanese application JP2003-342879 filed on Oct. 1, 2003, the content of which is hereby incorporated by reference into this application.

### BACKGROUND OF THE INVENTION

The present invention relates to a shared server employing an encoded data converter apparatus for ensuring confidentiality of personal information, and a terminal employing an encoded data decoding apparatus.

In recent years, computer systems for realizing local-governments are being developed. For letting residents and companies make access to such a system (electronic application system, etc.) of a local-government via the Internet, strict security management is essential and functions for the security management (firewall, portal authentication, etc.) and a proper infrastructure (authentication basis, etc.) become necessary. For round-the-clock operation of the system, it is also important to monitor the operating status and security status of the whole system. Further, for realizing smooth cooperation with financial institutions, a proper settlement/payment system has to be built up.

Such construction/introduction of the infrastructure/facilities for the computer system is financially very difficult for each local-government to carry out by itself. Further, securing the space for accommodating the facilities for the system is also generally difficult for each local-government. For such reasons, the construction of a shared communal center to be shared by a plurality of local-governments is being considered by many local-governments. In this case, a shared server of the shared communal center processes tasks that are common to the local-governments, while each computer terminal of each local-government connected to the back of the shared server processes tasks that are unique to the local-government. The shared server (local-government-shared server), installed in the shared communal center for the common use of the local-governments, is a Web server functioning as the core of the electronic application system, etc. By the unification and sharing among a plurality of local-governments, the costs of the construction and operation of the computer systems can be reduced considerably. An example of such a shared computer system has been disclosed in JP-A-2001-142956.

By the way, in the electronic application system, the local-government-shared server is connected to application terminals (for letting residents make applications to local-governments) via a network such as the Internet. The local-government-shared server is also connected to local-government terminals for letting staff members of the local-governments receive the applications from the residents (hereinafter simply referred to as “local-government terminals”) via a leased line network. In the system, application data (indicating the contents of an application) is transmitted from an application terminal to the local-government-shared server, and thereafter transmitted from the local-government-shared server to a local-government terminal as the destination of the application data. In the process, techniques for encoding are used in order to prevent leakage of the application data to a third party during the transmission on the network. Specifically, the application data (plain text data) inputted by a resident at the application terminal is encoded by a standard encoding protocol and the encoded data is transmitted to the local-government-shared server. In the local-government-shared server, the encoded data received from the application terminal is once decoded into the plain text data, and the plain text data is encoded by a purpose-built encoding protocol (exclusively for the local-government) and the encoded data is transmitted to the local-government terminal. In the local-government terminal, the encoded data received from the local-government-shared server is decoded into the application data (plain text data) and referred to and processed by a staff member of the local-government. In the process, there exists a step in which the encoded application data from the resident is once decoded into the plain text data in the local-government-shared server, and thus there is a possibility of leakage of personal information. In other words, such an electronic application system involves the problem of security holes (vulnerability of security).

### SUMMARY OF THE INVENTION

It is therefore the primary object of the present invention to provide measures for eliminating the security holes of the local-government-shared server and realizing high security data relay between terminals employing different encoding protocols.

In accordance with an aspect of the present invention, there are provided a local-government-shared server employing an encoded data converter apparatus and a local-government terminal employing an encoded data decoding apparatus to be used in a local-government system which comprises application terminals which are used by residents and companies for making applications to local-governments, local-government terminals which are used by the local-governments for receiving the applications from the residents and the companies, and the local-government-shared server which is connected to the application terminals and the local-government terminals by a network for relaying application data. The encoded data converter apparatus and the encoded data decoding apparatus are devices for converting or decoding encoded data while securing confidentiality of data held in the device.

The encoded data converter apparatus of the local-government-shared server converts first encoded data (generated by encoding the application data according to a first encoding method) received from the application terminal into second encoded data (generated by encoding the application data according to a second encoding method). Specifically, the encoded data converter apparatus decodes the first encoded data into plain text data according to the first encoding method, and thereafter encodes the plain text data into the second encoded data according to the second encoding method. While the conversion to the second encoded data is possible by the above process, the plain text data appears in the middle of the process. Therefore, the encoded data converter apparatus is provided with the protection function for preventing the contents of the temporarily appearing plain text data from being referred to from the outside of the apparatus.

The encoded data decoding apparatus of the local-government terminal decodes the application data (which has been encoded by a prescribed encoding method (second encoding method)) received from the local-government-shared server into plain text data according to the encoding method and holds the plain text data. While the plain text data held in the encoded data decoding apparatus can be displayed by an application data display module, access to the data from other devices, terminals, etc. has to be prohibited. Therefore, the encoded data decoding apparatus is provided with the protection function for preventing the contents of the plain text data held therein from being referred to from the outside of the apparatus.

The local-government-shared server stores the application data as follows. For the application data itself, a data number as a number unique to the application data is added to data obtained by encoding the application data according to the second encoding method, and the data obtained is stored as the second encoded data. Meanwhile, a reference record including the data number of the application data, attribute information (including the name of a local-government to which the application should be sent and the purpose of the application) and a key number corresponding to the second encoding method is generated for each application data and the generated reference records are accumulated as a reference table. The local-government-shared server transmits the application data to a proper local-government terminal as follows. Application data request information (including a data number and a key number) sent from a local-government terminal is compared with the reference table. In the comparison, if the reference table includes a reference record matching the data number and key number included in the application data request information, the second encoded data corresponding to the data number is transmitted to the local-government terminal. By the above process, each application data can be transmitted to a proper and corresponding local-government terminal while securing the confidentiality of the application data.

Incidentally, the “application terminal”, “local-government-shared server”, “local-government terminal” and “local-government system” in the appended claims correspond to “resident terminal”, “local-government terminal”, “local-government-shared server” and “electronic application system” in the following description of preferred embodiments, respectively.

### BRIEF DESCRIPTION OF THE DRAWINGS

The objects and features of the present invention will become more apparent from the consideration of the following detailed description taken in conjunction with the accompanying drawings, in which:

FIG. 1 is a block diagram showing the composition of an electronic application system in accordance with an embodiment of the present invention;

FIG. 2 is a table showing examples of plain text data, a correspondence table, a reference record and a reference table employed in the embodiment;

FIG. 3 is a table showing examples of key programs and encoded data employed in the embodiment;

FIG. 4 is a flow chart showing the operation of the electronic application system from the point when application data is inputted to a resident terminal by a resident to the point when the inputted application data is stored in a local-government-shared server; and

FIG. 5 is a flow chart showing the operation of the electronic application system from the point when a staff member of a local-government requests a reference table by use of a local-government terminal to the point when the staff member refers to the application data.

### DESCRIPTION OF THE EMBODIMENTS

Referring now to the drawings, a description will be given in detail of preferred embodiments in accordance with the present invention.

[Composition and Outline of Electronic Application System]

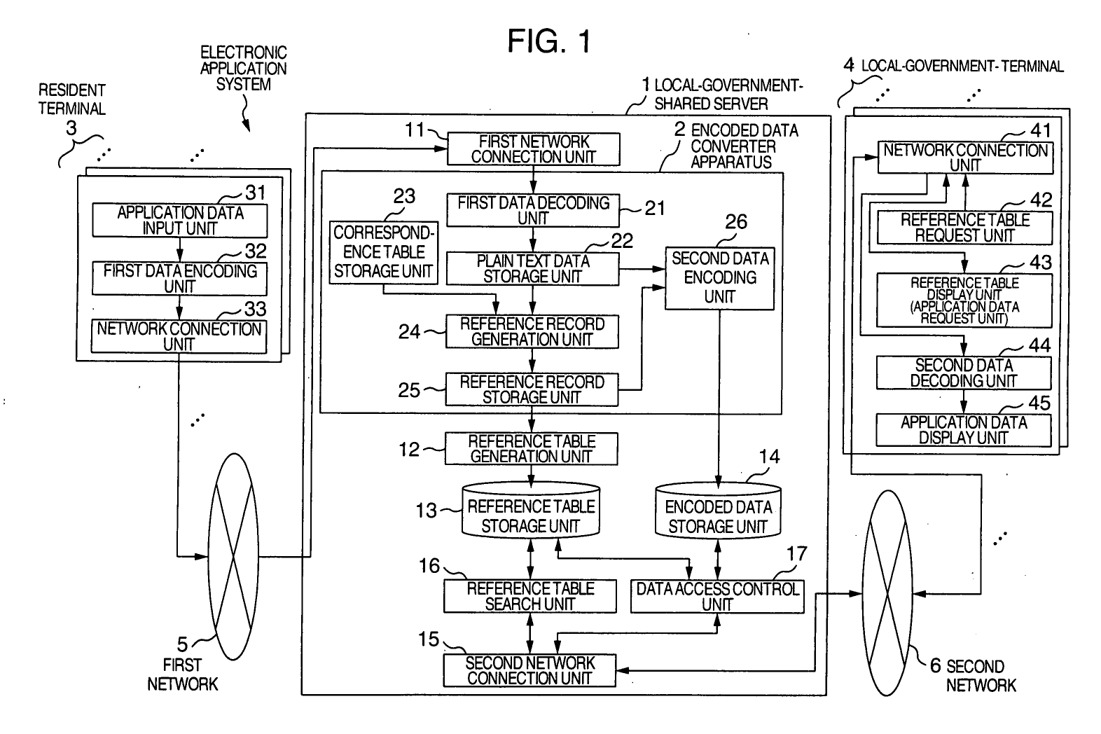

First, the composition and the outline of an electronic application system in accordance with an embodiment of the present invention will be described with reference to FIG. 1. The electronic application system includes a local-government-shared server 1 as a server shared by local-governments, a plurality of resident terminals 3 as terminals for residents and a plurality of local-government terminals 4 as terminals for the local-governments. The local-government-shared server 1 is connected to the resident terminals 3 via a first network 5 such as the Internet and a leased line network. Meanwhile, the local-government-shared server 1 is also connected to the local-government terminals 4 via a second network 6 which is a leased line network. The outline of the electronic application system is as follows. A resident inputs application data to be sent to a local-government by use of one of the resident terminals 3, and the inputted application data is transmitted to the local-government-shared server 1 via the first network 5. The local-government-shared server 1 receives the application data and temporarily stores the received application data in a prescribed storage unit. Meanwhile, a staff member of a local-government obtains application data that are relevant to a department of the local-government or a procedure handled by the local-government (out of all the application data stored in the local-government-shared server 1) via the second network 6 by use of one of the local-government terminals 4, and processes the application based on the obtained application data. In this case, there are mainly two methods for the local-government terminal 4 to obtain the application data stored in the local-government-shared server 1. One is the so-called push-type technology, in which the application data is sent from the local-government-shared server 1 to the local-government terminal 4 unilaterally. The other is the so-called pull-type technology, in which the local-government terminal 4 requests the local-government-shared server 1 to send the application data and in response to the request, the local-government-shared server 1 sends the requested application data to the local-government terminal 4. In this embodiment, the pull-type technology is assumed to be employed. The details of the method will be described later in an explanation of the operation of the system.

The local-government-shared server 1 is a Web server which is installed in a shared communal center, etc. shared by a plurality of local-governments, for the purpose of reducing the costs for the construction and operation of computer systems of the local-governments by unifying and sharing the server (as the core of the electronic application system) among the local-governments. The local-government-shared server 1 includes a first network connection unit 11, an encoded data converter apparatus 2, a reference table generation unit 12, a reference table storage unit 13, an encoded data storage unit 14, a second network connection unit 15, a reference table search unit 16, and a data access control unit 17.

The first network connection unit 11, implemented by a network connection device, is connected to a plurality of resident terminals 3 via the first network 5 to communicate encoded data, etc. with the resident terminals 3. The encoded data converter apparatus 2 receives the encoded data according to an external protocol from the first network connection unit 11 and outputs encoded data according to an internal protocol to the encoded data storage unit 14. In other words, the encoded data converter apparatus 2 has the function of converting the external protocol encoded data into the internal protocol encoded data. Here, the external protocol is a standard encoding protocol used between the local-government-shared server 1 and the resident terminals 3, such as the SSL (Secure Socket Layer). Meanwhile, the internal protocol is a purpose-built encoding protocol used between the local-government-shared server 1 and each local-government terminal 4, such as the symmetric key cryptography and the public key cryptography. The internal protocol can differ among the local-government terminals 4. The encoded data converter apparatus 2 also has a function of generating reference records (to be referred to by the local-government terminals 4) from the received encoded data and outputting the generated reference records to the reference table generation unit 12.

The reference table generation unit 12 receives the reference records from the encoded data converter apparatus 2 and adds the received reference records to a reference table stored in the reference table storage unit 13. Incidentally, the reference table storage unit 13 and the encoded data storage unit 14 are implemented by one or more nonvolatile storage devices such as an HDD (Hard Disk Drive), a flash memory, etc. Meanwhile, the second network connection unit 15, implemented by a network connection device, is connected to a plurality of local-government terminals 4 via the second network 6 to communicate encoded data, etc. with the local-government terminals 4. The reference table search unit 16 searches for the reference table stored in the reference table storage unit 13 according to reference table request information received from a local-government terminal 4 via the second network 6 and the second network connection unit 15, and transmits the obtained reference table to the local-government terminal 4 via the second network connection unit 15 and the second network 6. The data access control unit 17 obtains encoded data (corresponding to information received from a local-government terminal 4 via the second network 6 and the second network connection unit 15) from the encoded data storage unit 14 if there exists a reference record corresponding to the information in the reference table storage unit 13, and transmits the obtained encoded data to the local-government terminal 4 via the second network connection unit 15 and the second network 6. The data access control unit 17 also has a function of accumulating log information on data accesses made by the local-government terminals 4. Incidentally, the reference table generation unit 12, the reference table search unit 16 and the data access control unit 17 are implemented by a CPU (Central Processing Unit) of the local-government-shared server 1 running a prescribed program stored in a prescribed memory.

The encoded data converter apparatus 2 can generally be implemented by a so-called HSM (Hardware Security Module). The HSM is a device in the form of a board or drive to be inserted in a data bus of a PC (Personal Computer) or server, which physically secures the confidentiality of encoded modules and data. Depending on the security level, the HSM is provided with an extremely high tamper-resistant function (for protecting data from unauthorized access), a physical key/lock, or an encoding key backup function.

The encoded data converter apparatus 2 in accordance with the embodiment of the present invention is preferably installed in the local-government-shared server 1 and realizes the function of converting the external protocol encoded data (encoded data according to the external protocol) into the internal protocol encoded data (encoded data according to one of the internal protocols) while securing the confidentiality of plain text data (unencoded text data) which is generated by decoding during the protocol conversion. Further, for the application to the electronic application system of each local-government, the encoded data converter apparatus 2 also realizes a function of generating a reference record (to be referred to by a local-government terminal 4 before obtaining application data) corresponding to each application data. The function of generating the reference record is implemented according to an attribute information/key number correspondence table (explained later) which is set by a user (staff member of a local-government), and thus it can be regarded as a function implemented by separate user settings.

Incidentally, the encoded data converter apparatus 2 may also be implemented by other hardware, software, etc. instead of the HSM as long as the aforementioned functions can be achieved.

As shown in FIG. 1, the encoded data converter apparatus 2 includes a first data decoding unit 21, a plain text data storage unit 22, a correspondence table storage unit 23, a reference record generation unit 24, a reference record storage unit 25, and a second data encoding unit 26. The first data decoding unit 21 receives encoded data from the first network connection unit 11, decodes the received encoded data into plain text data, and stores the plain text data in the plain text data storage unit 22. The correspondence table storage unit 23 stores the aforementioned attribute information/key number correspondence table (hereinafter referred to simply as a “correspondence table”) which indicates the correspondence between attribute information contained in the plain text data (application data) and a key number which is unique to an encoding key program (hereinafter simply referred to as a “key program”) used between the local-government-shared server 1 and a local-government terminal 4. The reference record generation unit 24 generates a reference record by adding a corresponding key number (associated by the correspondence table with the attribute information of the plain text data) to a part of the plain text data stored in the plain text data storage unit 22, and stores the generated reference record in the reference record storage unit 25. The reference record storage unit 25 outputs the stored reference record to the reference table generation unit 12. The second data encoding unit 26 is provided with each key program as an encoding program (program for implementing the encoding by use of each internal protocol) used for the communication with each local-government terminal 4. Each key program can be activated by each key number which is unique to the key program, by which the encoded data are generated. Concretely, the key number contained in the reference record stored in the reference record storage unit 25 is inputted to the second data encoding unit 26, a key program corresponding to the inputted key number is activated, and thereby the plain text data stored in the plain text data storage unit 22 is encoded. Thereafter, the encoded data is outputted to the encoded data storage unit 14. Incidentally, the plain text data storage unit 22, the correspondence table storage unit 23 and the reference record storage unit 25 are implemented by memory such as a RAM (Random Access Memory). The first data decoding unit 21, the reference record generation unit 24 and the second data encoding unit 26 are implemented by the CPU running a prescribed program stored in a prescribed memory.

Each resident terminal 3 is a terminal for letting the residents make various applications to their local-governments. Specifically, the resident terminal 3 may either be a PC installed in a house of a resident or an application terminal installed in an office of a local-government. As shown in FIG. 1, the resident terminal 3 includes an application data input unit 31, a first data encoding unit 32, and a network connection unit 33. The application data input unit 31 displays a screen for letting the residents input the application data, receives the input of the application data, generates plain text data of a prescribed format containing the inputted application data, and outputs the generated plain text data to the first data encoding unit 32. The application data input unit 31 is implemented mainly by a display, a pointing device such as a mouse, a keyboard, etc. and partially by a program run by a CPU of the resident terminal 3. The first data encoding unit 32 encodes data according to the external protocol used between the resident terminal 3 and the local-government-shared server 1. Specifically, the first data encoding unit 32 encodes the plain text data supplied from the application data input unit 31 and outputs the encoded data to the network connection unit 33. The first data encoding unit 32 is implemented by the CPU running a prescribed program. The network connection unit 33, implemented by a network connection device, is connected to the local-government-shared server 1 via the first network 5 for carrying out the transmission of the encoded data supplied from the first data encoding unit 32, etc.

Each local-government terminal 4 is a PC terminal for letting the staff of each local-government refer to the application data from the residents and process the applications based on the application data. The local-government terminal 4 may be installed either in an office of a local-government or in the shared communal center where the local-government-shared server 1 is installed. As shown in FIG. 1, the local-government terminal 4 includes a network connection unit 41, a reference table request unit 42, a reference table display unit 43, a second data decoding unit 44, and an application data display unit 45. The network connection unit 41, implemented by a network connection device, is connected to the local-government-shared server 1 via the second network 6 to communicate the encoded data, etc. with the local-government-shared server 1. The reference table request unit 42 is for letting the local-governmental staff check application data currently stored in the local-government-shared server 1. The reference table request unit 42 may be used either for requesting all data of the reference table or for requesting a search for a reference table regarding the local-government itself. Specifically, when a staff member of the local-government finishes inputting search conditions, etc. and makes an input indicating the end of the input, the reference table request unit 42 transmits the aforementioned reference table request information (according to the contents of the input) to the local-government-shared server 1 via the network connection unit 41 and the second network 6. The reference table display unit 43, implemented by a display, etc. displays a response of the local-government-shared server 1 to the reference table request information, that is, a search result of the reference table. The local-governmental staff seeing the reference table displayed on the reference table display unit 43 selects a data number of application data to be requested, by which request information including the selected data number is transmitted to the local-government-shared server 1. In this sense, the reference table display unit 43 can also be regarded as an application data request unit.

The second data decoding unit 44 receives the response of the local-government-shared server 1 to the transmitted data number, etc. (i.e. the encoded data generated by encoding the application data), decodes the received encoded data into plain text data by use of its own key program, and outputs the plain text data (application data) to the application data display unit 45. The second data decoding unit 44 may either be implemented by the CPU running a prescribed program or the aforementioned HSM (encoded data decoding apparatus, in this case). When the HSM is employed, the contents of memory storing the plain text data can not be referred to from the outside of the HSM, by which the confidentiality of the application data can be secured. The application data display unit 45 displays the plain text data supplied from the second data decoding unit 44. Incidentally, the reference table request unit 42, the reference table display unit 43 and the application data display unit 45 are implemented by a display, a pointing device such as a mouse, a keyboard, etc.

[Composition and Outline of Data]

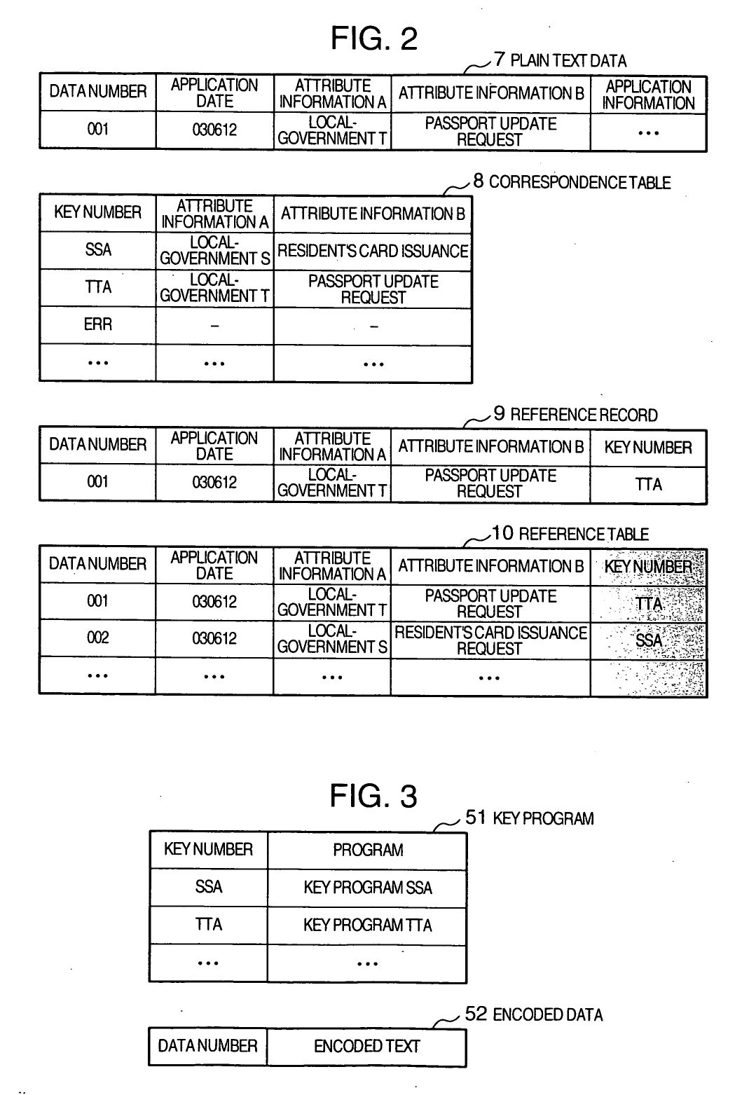

In the following, the composition (format) and the outline of data processed by the electronic application system of this embodiment will be described with reference to FIGS. 2 and 3.

FIG. 2 is a table showing examples of the plain text data 7, the correspondence table 8, the reference record 9 and the reference table 10. The plain text data 7 is the application data which is generated by the application data input unit 31 of the resident terminal 3, the plain text data which is stored in the plain text data storage unit 22 of the encoded data converter apparatus 2 of the local-government-shared server 1, and the application data which is displayed by the application data display unit 45 of the local-government terminal 4. The plain text data 7 includes a data number, an application date, attribute information A, attribute information B, and application information. The data number is a number which is assigned to be unique to the application data. For example, the data number may be assigned using numeric data (indicating the order of access) which is returned from the local-government-shared server 1 to the resident terminal 3 when the resident using the resident terminal 3 logs in to the local-government-shared server 1 for inputting the application data. The application date indicates the date of the input of the application data, which is set to a date obtained from a clock function of the resident terminal 3. The attribute information A indicates the name of the local-government as the destination of the application. The attribute information B indicates the purpose of the application. The application information includes personal information which is required depending on the purpose of the application. The attribute information A and B and the application information are inputted by the resident through the resident terminal 3.

The correspondence table 8 is the table which is stored in the correspondence table storage unit 23 of the encoded data converter apparatus 2 of the local-government-shared server 1 and which is referred to by the reference record generation unit 24. The correspondence table 8 includes a key number, the attribute information A, and the attribute information B. The key number, a number unique to the key program implementing the internal protocol, is set corresponding to the key program employed in the electronic application system of each local-government. Thus, the key number also corresponds to the second data decoding unit 44 of the local-government terminal 4 and can be identified by the attribute information A and B. However, there are cases where the combination of the attribute information A and B does not exist in the correspondence table 8 due to an input error by the resident or network failure. To cope with such cases, a key number “ERR” is employed. A data decoding unit corresponding to the key number ERR is provided not to local-government terminals 4 but to the local-government-shared server 1, with which staff members having particular authority can refer to such application data.

The reference record 9 is the record generated by the reference record generation unit 24 and stored in the reference record storage unit 25. The reference record 9 includes the data number, the application date, the attribute information A, the attribute information B, and the key number. In other words, the reference record 9 is data obtained by removing the application information from the plain text data 7 and adding the key number.

The reference table 10 is the table which is generated by the reference table generation unit 12 of the local-government-shared server 1, stored in the reference table storage unit 13, requested by the reference table request unit 42 of the local-government terminal 4, and displayed by the reference table display unit 43. The reference table 10 is formed by accumulating the reference records 9. Incidentally, while the key number can be referred to from the inside of the local-government-shared server 1, reference to the key number from the outside of the local-government-shared server 1 is not allowed. Thus, the reference table display unit 43 of the local-government terminal 4 obtains the reference table from which the key numbers have been removed, and displays the reference table without the key numbers.

FIG. 3 is a table showing examples of the key programs 51 and the encoded data 52. Each key program 51, for implementing the data encoding by each internal protocol, is provided to the second data encoding unit 26. The key program 51 includes the key number and a program. Each program (the key program in an executable form) is stored corresponding to each key number.

The encoded data 52 is the data outputted by the second data encoding unit 26 and stored in the encoded data storage unit 14. The encoded data 52 includes the data number and an encoded text. The encoded text is data generated by encoding the plain text data 7. The encoded data 52 is formed by adding the data number to the encoded text. By the addition of the data number to the encoded text, the encoded data 52 can be associated with the reference table 10 by the data number.

[Operation of Electronic Application System]

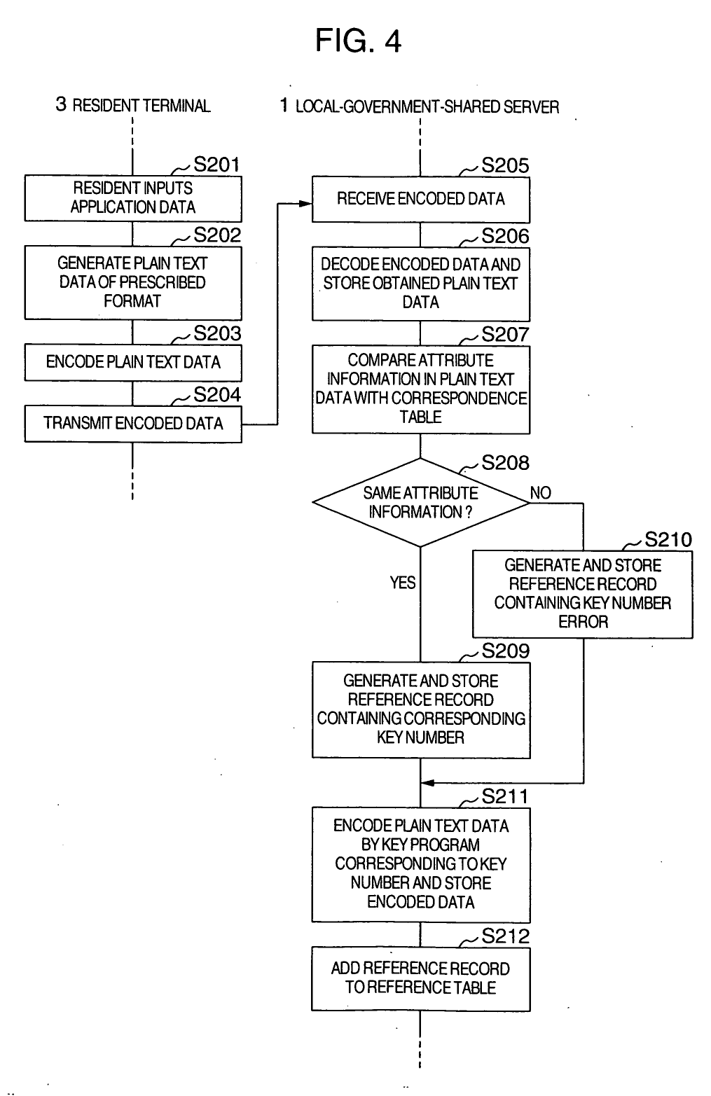

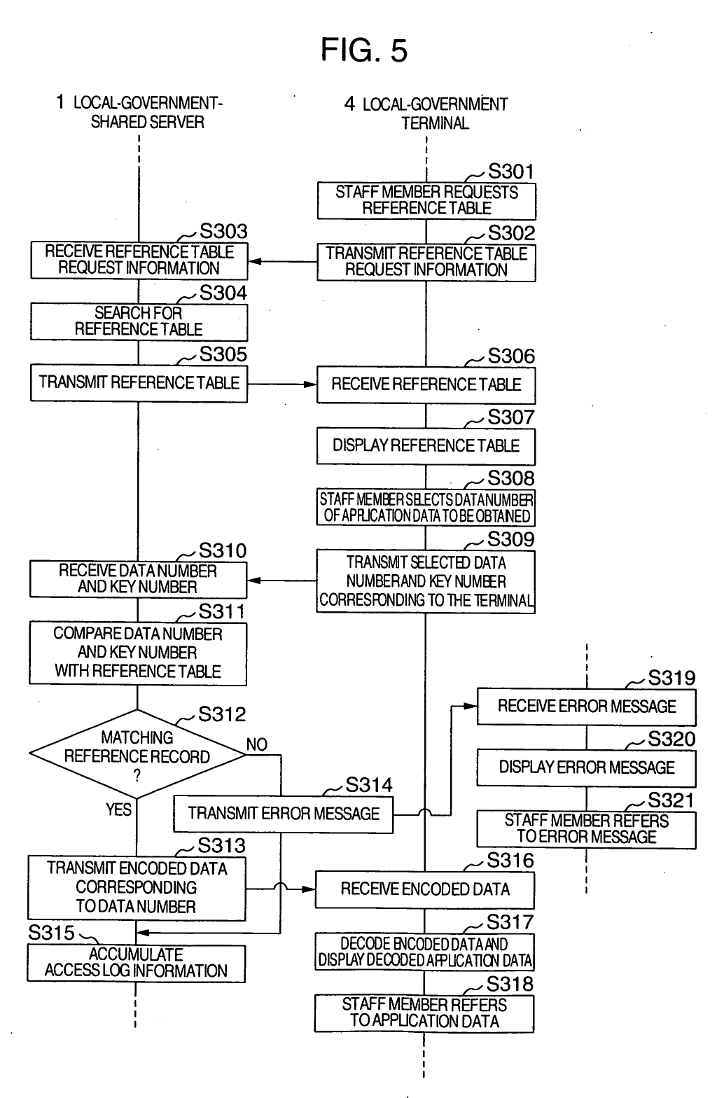

In the following, the operation of the electronic application system of this embodiment will be described with reference to FIGS. 4 and 5 (see FIGS. 1-3 as needed). FIG. 4 is a flow chart showing the operation of the electronic application system from the point when application data is inputted to a resident terminal 3 by a resident to the point when the application data is stored in the local-government-shared server 1. First, the resident at the resident terminal 3 inputs the application data to be sent to the local-government (step S201). In this step, the resident inputs the attribute information A (the name of the local-government as the destination of the application), the attribute information B (the purpose of the application) and the application information (the personal information required depending on the purpose of the application), as the application data to be included in the plain text data 7. Subsequently, the application data input unit 31 generates the plain text data 7 of a prescribed format (step S202). In the plain text data 7 the data number is set according to the aforementioned numeric data indicating the order of access (logging in to the local-government-shared server 1), the application date is set to the date obtained from the clock function of the resident terminal 3, and the attribute information A and B and the application information are set according to the input by the resident. Subsequently, the first data encoding unit 32 encodes the plain text data 7 supplied from the application data input unit 31 according to the external protocol (step S203). Thereafter, the network connection unit 33 transmits the encoded data to the local-government-shared server 1 via the first network 5 (step S204).

In the local-government-shared server 1, the first network connection unit 11 receives the encoded data transmitted from the resident terminal 3 (step S205). The first data decoding unit 21 of the encoded data converter apparatus 2 decodes the encoded data into the plain text data according to the external protocol and stores the plain text data in the plain text data storage unit 22 (step S206). Subsequently, the reference record generation unit 24 compares the attribute information A and B contained in the plain text data 7 with the correspondence table 8 stored in the correspondence table storage unit 23 (step S207). In the comparison, if the same combination of the attribute information A and B exists in the correspondence table 8 (step S208: YES), the reference record generation unit 24 generates a reference record 9 containing a key number corresponding to the combination and stores the generated reference record 9 in the reference record storage unit 25 (step S209). In this case, the reference record is generated by removing the application information from the plain text data 7 and adding the corresponding key number. If the same combination of the attribute information A and B does not exist in the correspondence table 8 (step S208: NO), the reference record generation unit 24 generates a reference record 9 containing the key number ERR indicating the disagreement error and stores the generated reference record 9 in the reference record storage unit 25 (step S210). In this case, the reference record is generated by removing the application information from the plain text data 7 and adding the key number ERR.

Subsequently, the second data encoding unit 26 obtains the reference record 9 and the plain text data 7 from the reference record storage unit 25 and the plain text data storage unit 22 respectively, encodes the plain text data 7 by a key program (program which implements the encoding according to the internal protocol) corresponding to the key number of the reference record 9, and stores the encoded data 52 in the encoded data storage unit 14 (step S211). In this case, the encoded data 52 stored in the encoded data storage unit 14 is the encoded text (generated by encoding the plain text data 7) and the data number added together. Meanwhile, the reference table generation unit 12 obtains the reference record 9 from the reference record storage unit 25 and adds the obtained reference record 9 to the reference table 10 stored in the reference table storage unit 13 (step S212). Specifically, the reference table generation unit 12 obtains the current reference table 10 from the reference table storage unit 13, adds the reference record 9 to the bottom of the obtained reference table 10, and stores the new reference table 10 in the reference table storage unit 13. By the above steps, the application data inputted to the resident terminal 3 is stored in the encoded data storage unit 14 of the local-government-shared server 1 as the encoded data 52 according to the internal protocol while the reference record 9 of the application data is added to the reference table 10 stored in the reference table storage unit 13, that is, it becomes possible for a local-government terminal 4 to obtain the application data.

FIG. 5 is a flow chart showing the operation of the electronic application system from the point when a staff member of a local-government requests the reference table 10 by use of a local-government terminal 4 to the point when the staff member refers to the application data. First, the staff member at the local-government terminal 4 requests the reference table 10 (step S301). In this step, the staff member may either request the whole reference table 10 by inputting such a command or narrow the target of reference by inputting a search condition regarding the attribute information A or B. Subsequently, the reference table request unit 42 generates the reference table request information according to the contents of the input and transmits the reference table request information to the local-government-shared server 1 via the network connection unit 41 (step S302).

In the local-government-shared server 1, the second network connection unit 15 receives the reference table request information transmitted from the local-government terminal 4 (step S303) and outputs the received reference table request information to the reference table search unit 16. The reference table search unit 16 receives the reference table request information from the second network connection unit 15, searches for the reference table 10 stored in the reference table storage unit 13 based on the reference table request information (step S304), and transmits the reference table obtained as the search result (all or part of the reference table 10 stored in the reference table storage unit 13) to the local-government terminal 4 via the second network connection unit 15 (step S305). Incidentally, the reference table transmitted from the local-government-shared server 1 does not contain the key numbers.

In the local-government terminal 4, the network connection unit 41 receives the reference table from the local-government-shared server 1 (step S306) and outputs the received reference table to the reference table display unit 43. The reference table display unit 43 receives the reference table from the network connection unit 41 and displays the reference table (step S307). The staff member, seeing the application dates and attribute information A and B in the displayed reference table, selects a data number of application data that should be obtained, by use of a mouse, etc. (step S308). The reference table display unit 43 (as the application data request unit) transmits the selected data number and a key number corresponding to the second data decoding unit 44 of the local-government terminal 4- to the local-government-shared server 1 via the network connection unit 41 (step S309).

In the local-government-shared server 1, the second network connection unit 15 receives the data number and the key number from the local-government terminal 4 (step S310) and outputs the received data number and key number to the data access control unit 17. The data access control unit 17 receives the data number and key number from the second network connection unit 15 and compares the received data number and key number with the reference table 10 stored in the reference table storage unit 13 (step S311). In the comparison, if the reference table 10 contains a reference record matching the data number and key number (step S312: YES), the data access control unit 17 obtains encoded data 52 corresponding to the data number from the encoded data storage unit 14 and transmits part of the obtained encoded data 52 to the local-government terminal 4 via the second network connection unit 15 (step S313). In this case, the encoded data transmitted from the local-government-shared server 1 is the encoded text which is obtained by removing the data number from the encoded data 52. If the reference table 10 does not contain a reference record matching the data number and key number (step S312: NO), an error message is transmitted to the local-government terminal 4 (step S314). The data access control unit 17 also accumulates access log information on the local-government terminal 4 (step S315).

In the local-government terminal 4, the network connection unit 41 receives the encoded data from the local-government-shared server 1 (step S316) and outputs the received encoded data to the second data decoding unit 44. The second data decoding unit 44 receives the encoded data from the network connection unit 41, decodes the encoded data into plain text data (application data) according to the internal protocol, and lets the application data display unit 45 display the application data (step S317). The staff member refers to the application data displayed on the application data display unit 45 (step S318) and processes the application by a prescribed procedure. On the other hand, when the network connection unit 41 receives the error message from the local-government-shared server 1 (step S319), the error message is displayed on an unshown prescribed display unit (step S320). In this case, the staff member refers to the error message (step S321) and investigates the cause of the error message.

The above electronic application system in accordance with the embodiment of the present invention is typically realized by programs for implementing the functions of the units shown in FIG. 1. Such programs are stored in computer-readable record mediums and supplied to computer systems (local-government-shared server 1, resident terminals 3, local-government terminals 4). The program stored in the record medium is read out and run by each computer system, by which the electronic application system of the embodiment is realized. The computer system mentioned here includes software such as an OS (Operating System) and hardware such as peripheral devices.

(Other Embodiment)

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention. For example, when the reference table request information transmitted from a local-government terminal 4 is received by the reference table search unit 16 of the local-government-shared server 1, the reference table search unit 16 may carry out the search by restricting the search target to reference records having the attribute information A matching the local-government transmitting the reference table request information, in order to reinforce the security of each local-government terminal 4. By such composition, even when there are two or more local-government terminals 4 using the same internal protocol, the application data (encoded data) is prevented from being transmitted to a wrong local-government terminal 4 different from the local-government terminal 4 to which the application data should be sent.

As set forth hereinabove, by the present invention, the confidentiality of plain text data is secured by the encoded data converter apparatus of the local-government-shared server, by which the local-government-shared server is allowed to relay and transfer the application data between the application terminal (resident terminal, etc.) and the local-government terminal with high security.

Similarly, the confidentiality of plain text data is secured also by the encoded data decoding apparatus (second data decoding unit 44) of the local-government terminal, by which the application data can be protected from irrelevant access for purposes other than the display of application data.

Further, the local-government-shared server is capable of transmitting the application data corresponding to each local-government terminal while securing the confidentiality of the application data. Therefore, an electronic application system realizing secure protection of personal information can be provided to residents, companies, etc.

It should be further understood by those skilled in the art that although the foregoing description has been made on embodiments of the invention, the invention is not limited thereto and various changes and modifications may be made without departing from the spirit of the invention and the scope of the appended claims.

1. A local-government-shared server employing an encoded data converter apparatus in a local-government system which comprises application terminals which are used by residents and companies for making applications to local-government, local-government terminals which are used by the local-government for receiving the applications from the residents and the companies, and the local-government-shared server which is connected to the application terminals and the local-government terminals by a network for relaying application data, comprising:
a first network connection module which is connected to the application terminals via a first network for receiving first encoded data as the application data encoded according to a first encoding method from an application terminal;
the encoded data converter apparatus which receives the first encoded data from the first network connection module and outputs second encoded data as the application data encoded according to a second encoding method while securing confidentiality of data held in the apparatus;
an encoded data storage module which receives the second encoded data from the encoded data converter apparatus and stores the received second encoded data; and
a second network connection module which is connected to the local-government terminals via a second network for obtaining the second encoded data from the encoded data storage module and transmitting the second encoded data to the local-government terminal.

2. The local-government-shared server according to claim 1, wherein the encoded data converter apparatus includes:
a data decoding module which receives the first encoded data from the first network connection module, decodes the received first encoded data according to the first encoding method, and outputs plain text data obtained by the decoding;
a plain text data storage module which receives the plain text data from the data decoding module and stores the received plain text data; and
a data encoding module which obtains the plain text data from the plain text data storage module, encodes the obtained plain text data into the second encoded data according to the second encoding method, and outputs the second encoded data to the encoded data storage module.

3. The local-government-shared server according to claim 2, wherein:
the plain text data at least includes a data number as a number unique to the application data, attribute information including the name of a local-government to which the application should be sent and the purpose of the application, and application information as information required depending on the purpose of the application, and
the encoded data converter apparatus further includes:
a correspondence table storage module which stores a correspondence table indicating correspondence between the attribute information and a key number as a number unique to the second encoding method;
a reference record generation module which obtains the data number and the attribute information from the plain text data storage module, identifying a key number corresponding to the obtained attribute information by comparing the attribute information with the correspondence table stored in the correspondence table storage module, and outputs a reference record including the obtained data number and attribute information and the identified key number; and
a reference record storage module which receives the reference record from the reference record generation module and stores the received reference record, and
the data encoding module identifies the second encoding method by the key number included in the reference record stored in the reference record storage module, encodes the plain text data into an encoded text according to the identified second encoding method, and outputs the second encoded data including the encoded text and the data number to the encoded data storage module, and
the local-government-shared server further comprises:
a reference table generation module which obtains the reference record from the reference record storage module, adds the obtained reference record to a reference table at the point in time, and thereby generates a new reference table; and
a reference table storage module which receives the reference table generated by the reference table generation module and stores the received reference table.

4. The local-government-shared server according to claim 3, further comprising:
a reference table search module which receives reference table request information including at least a search condition from the local-government terminal via the second network connection module, searches for the reference table stored in the reference table storage module according to the received reference table request information, and transmits the result of the search to the local-government terminal via the second network connection module; and
a data access control module which receives application data request information including the data number and the key number from the local-government terminal via the second network connection module, obtains second encoded data corresponding to the received data number from the encoded data storage module if the reference table includes a reference record matching the received data number and key number, and transmits the obtained second encoded data to the local-government terminal via the second network connection module.

5. A local-government terminal employing an encoded data decoding apparatus in a local-government system which comprises application terminals which are used by residents and companies for making applications to local-government, local-government terminals which are used by the local-government for receiving the applications from the residents and the companies, and a local-government-shared server which is connected to the application terminals and the local-government terminals by a network for relaying application data, comprising:
a network connection module which is connected to the local-government-shared server via the network for receiving encoded data as the application data encoded according to a prescribed encoding method from the local-government-shared server;
the encoded data decoding apparatus which receives the encoded data from the network connection module, decodes the received encoded data into the application data according to the prescribed encoding method, and outputs the decoded application data while securing confidentiality of data held in the apparatus; and
an application data display module which receives the application data from the encoded data decoding apparatus and displays the received application data.

6. The local-government terminal according to claim 5, further comprising:
a reference table request module which generates reference table request information based on a search condition inputted by a staff member of a local-government for searching for a reference table stored in the local-government-shared server and transmits the generated reference table request information to the local-government-shared server via the network connection module, the reference table including a plurality of reference records each of which includes at least a data number as a number unique to each application data and attribute information including the name of a local-government to which the application should be sent and the purpose of the application;
a reference table display module which receives the reference table from the local-government-shared server via the network connection module as the response to the reference table request information and displays the received reference table; and
an application data request module which requests the application data by transmitting a data number selected by local-government staff member from the displayed reference table and a key number as a number unique to an encoding method of the encoded data decoding apparatus to the local-government-shared server via the network connection module.
